(19) United States
(12) Patent Application Publication
(10) Pub. No.: US 2006/0093813 A1
(43) Pub. Date: May 4, 2006

(54) Durable layer composition for in-mold decoration

(76) Inventors: Fei Wang, Newark, CA (US); Haiyan Gu, Fremont, CA (US); Pei-Lin Wang, San Jose, CA (US); Xiaojia Wang, Fremont, CA (US); Wan Peter Hsu, Fremont, CA (US)

Correspondence Address: HOWREY LLP, C/O IP DOCKETING DEPARTMENT, 2941 FAIRVIEW PARK DRIVE, SUITE 200 & 300, FALLS CHURCH, VA, 22042-2924, US

(21) Appl. No.: 11/102,226

(22) Filed: Apr. 7, 2005

Related U.S. Application Data
(60) Provisional application No. 60/624,126, filed on Oct. 28, 2004.

(51) Int. Cl. B32B 7/12

(52) U.S. Cl. 428/354; 522/178

(57) ABSTRACT

This invention relates to a durable layer composition for in-mold decoration.

### RELATED APPLICATION

This application claims the priority under 35 USC 119(e) of U.S. Provisional Application No. 60/624,126 filed on Oct. 28, 2004, the content of which is incorporated herein by reference in its entirety.

### FIELD OF THE INVENTION

This invention relates to a composition suitable for a durable layer used in an in-mold decoration process.

### BACKGROUND OF THE INVENTION

In-mold decoration processes involve decorating articles as they are formed, in mold, of a heated plastic material being injected into a mold cavity. Usually a tape or strip of a decorative or protective material is automatically or manually advanced, pre-fed and positioned in the mold cavity at each molding cycle, interfacing therein with the plastic material as it is filled into the mold cavity, under heat and pressure. As the article is formed, the decorative material forms on the surface of the article and becomes an integral and permanent part of the article, through thermal transfer in the in-mold decoration process. Other molding processes such as thermal forming, blow molding and compression molding or stamping may also be used for the transfer of the decorative or protective material. Sometimes the process may also be called in-mold labeling or in-mold coating, and the transferable protective material may be called a thermal transfer overcoat or durable coat layer.

The decoration tape or strip usually comprises a carrier layer, a release layer, a durable layer, an adhesive or tie-coat layer and also a layer of decorative designs (metal or ink). After the injection molding transfer, the carrier layer and the release layer are removed, leaving the durable layer as the outmost layer. The durable layer therefore is an essential part of the decorative tape or strip as it serves as a protective layer with scratch resistance, mar or abrasion resistance and solvent resistance to protect the decorative designs and also the molded article.

An effective durable layer must meet certain criteria. For example, it needs to be a non-tacky or non-blocking coating to allow roll-up and also to be able to tolerate subsequent image forming conditions. Secondly it needs to be conformable during the injection molding process to adapt to the 3D shape of the molded article. In addition, an effective durable layer needs to be able to withstand a high shear force and high temperature polymer melt in the injection molding process. Furthermore, it needs to have excellent solvent and abrasion resistance to protect the decorative image during usage.

U.S. Pat. No. 5,795,527 discloses an in-mold decoration process in which a protective layer known as the hard coat layer is formed from a UV or electron beam curable resin. U.S. Pat. No. 5,955,204 discloses a transfer material which has an UV absorbing layer as a protective layer. The UV absorbing layer contains an acrylic polymer in which a skeleton having an UV absorbing property is introduced onto the molecular chains. These durable layers, however, tend to crack or show defects if the layer is fully cured before molding. This is especially the case if a sharp curvature or steep step height is a critical feature of the molded article. On the other hand, a partially cured or under-cured durable layer is often not sufficiently hard for subsequent processing steps (e.g., sputtering or vapor deposition and the patterning of a metallic decoration layer which is a very desirable feature for most applications).

U.S. Pat. Nos. 5,993,588 and 6,527,898 disclose a protecting layer partially cured by thermal energy followed by a UV post cure after the molding process. These references allege that the compositions disclosed therein may represent an advancement of the protecting layers and provide protecting layers which have improved abrasion and chemical resistance and show less tendency to crack at the curved part of the surface of a molded article. However, such protecting layers have certain disadvantages. First of all, the synthesis and purification of a highly acrylated polymer with reactive hydroxyl group(s) for thermal crosslinking are expensive and time-consuming. The acrylated acrylic polymer needs to be synthesized via a two-steps reaction: formation of acrylic polymer backbones and grafting of acrylic functional groups. Side reactions, such as gellation may happen during the second grafting steps and render the synthetic procedure difficult to control and the produced polymer with limited shelve life. In addition, in order to achieve a metallic decorative layer of high gloss, the partially thermal-cured durable layer preferably has a high heat distortion temperature and yet still has (1) high photo-reactivity for the UV post curing at a high speed to achieve acceptable scratch resistance, solvent resistance and hardness, and (2) high flexibility for 3D contour molding. Unfortunately these requirements tend to be in conflict and as a result, the durable layer compositions often have a narrow process window for optimum metal deposition and the molding/post curing processes. The durable/protective layer and the in-mold decoration foil resulted from any of these methods tend to be brittle and show defects such as cracking and dust particles during handling and conversion. Furthermore, the thermal partial curing of the durable layer composition in a production coater tends to be difficult to control. A high speed crosslinking required for low cost production often results in a short storage stability or green time of the coating fluid. It is highly desirable that a high rate of crosslinking in the coater is achieved by a wider coating process window with a more stable composition.

### SUMMARY OF THE INVENTION

The first aspect of the present invention is directed to a composition useful for the formation of a durable layer used in an in-mold coating, decoration or labeling process. The composition comprises (i) an amino crosslinker, (ii) a UV curable monomer or oligomer having at least one functional group reactive with the amino crosslinker, (iii) an acid catalyst, and (iv) a photoinitiator.

In the formation of a durable layer of the present invention, the amino crosslinker may form a network through self-crosslinking and through the reaction of the functional group on the UV curable monomer or oligomer with the amino group on the amino crosslinker. The formation of the network is accomplished under acidic and thermal curing conditions. After the injection molding process, the network already formed through thermal curing may be further reinforced through UV curing of the UV curable monomer or oligomer. This post UV exposure effectively provides additional crosslinking to form a fully interpenetration network as a highly durable protective layer for the molded article.

The durable layer composition of the present invention may further comprise one or more of the following components: a binder, a multifunctional polymer or oligomer that can react with the amino crosslinker, a filler, an adhesion promoter or an antioxidant.

In addition, the durable layer composition of the present invention may further comprise additives such as a photosensitizer, an oxygen scavenger, a UV absorber or light stabilizer, a lubricant or a colorant.

The second aspect of the present invention is directed to an in-mold decoration process for the manufacture of an article having a durable layer of the present invention.

The third aspect of the present invention is directed to a plastic article having a durable layer of the present invention on its top surface.

The fourth aspect of the present invention is direct to a plastic article comprising a durable layer of the present invention and a decorative metallic layer and/or an ink layer.

The present invention achieves the purpose of providing a durable layer for in-mold decoration which has excellent surface qualities (e.g., hardness, abrasion resistance, chemical resistance and thermal stability) with a wider geometric tolerance, at low cost. In addition, the durable layer of the present invention also allows an easier and wider processing window for subsequent image forming steps.

### BRIEF DESCRIPTION OF THE DRAWINGS

FIG. 1 is a cross section view of an in-mold decoration tape or strip.

FIG. 2 shows how the in-mold decoration tape or strip is fed into a mold cavity.

### DETAILED DESCRIPTION OF THE INVENTION

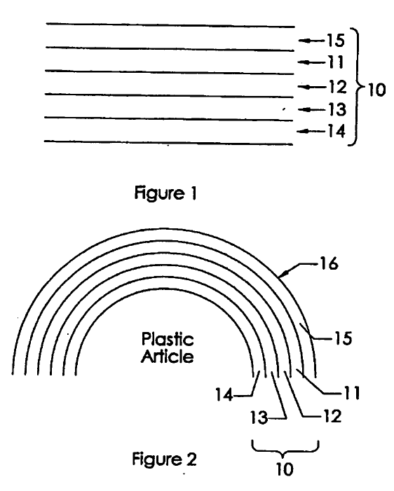

FIG. 1 is a cross-section view of an in-mold decoration tape or strip (10) which comprises a carrier layer (15), a release layer (11), a durable layer (12), a decorative design layer (13), and an adhesive layer (14).

In an in-mold decoration process, the tape or strip (10) is fed into a mold cavity (16) automatically or manually with the carrier layer (15) in contact with the mold surface as shown in FIG. 2. The tape or strip may be thermally formed to a desirable shape before the feeding step.

The carrier (15), release (11) and adhesive (14) layers may be formed by methods known in the art and all of the previously known carrier, release and adhesive layers may be incorporated into the present invention.

For example, the carrier layer (15) usually is a thin plastic film with a thickness from about 3.5 to about 100 microns, preferably about 10 to about 50 microns. Polypropylene (PP), polyethylene terephthalate (PET), polyethylene naphthate (PEN) or polycarbonate (PC) films are particularly preferred because of their low cost, high transparency and thermomechanical stability.

The release layer (11) allows the in-mold decoration tape or strip to be released from the carrier layer in a manner that minimizes damage to the durable layer (12) and the decorative layer (13) and also enables a fully automated roll transfer process during molding. The release layer usually is a low surface tension coating prepared from a material such as wax, paraffin or silicone or a highly smooth and impermeable coating prepared from a material selected from the group consisting of melamine formaldehyde, metal thin film such as Al or Sn, crosslinked polyacrylates, silicone acrylates, epoxides, vinyl esters, vinyl ethers, allyls and vinyls, unsaturated polyesters or blends thereof. The release layer may comprise a condensation polymer, copolymer, blend or composite selected from the group consisting of epoxy, polyurethane, polyimide, polyamide, melamine formaldehyde, urea formaldehyde, phenol formaldehyde and the like.

The release layer as disclosed in U.S. Ser. No. 60/564,018, filed on Apr. 20, 2004, the content of which is incorporated herein by reference in its entirety, is also suitable. Such a release layer composition comprises an amine-aldehyde condensate and a radical inhibitor or quencher.

Some carriers may have sufficient release properties to be used as a release layer.

The adhesive layer (14) is incorporated into the in-mold decoration tape or strip to provide optimum adhesion of the decorative layer to the top surface of the molded article. The adhesive layer may be formed from a material such as polyacrylate, polymethacrylate, polystyrene, polycarbonate, polyurethane, polyester, polyamide, epoxy resin, ethylene vinylacetate copolymers (EVA), thermoplastic elastomers or the like, or a copolymer, blend or composite thereof. Hot melt or heat activated adhesives such as polyurethane and polyamide are particularly preferred. The thickness of the adhesive layer may be in the range of about 1 to about 20 microns, preferably in the range of about 2 to about 6 microns.

The adhesive layer as disclosed in U.S. Ser. No. 60/589,708, filed on Jul. 20, 2004, the content of which is incorporated herein by reference in its entirety, is also suitable. Such an adhesive layer composition comprises an adhesive binder and a polymeric particulate material.

The decorative layer (13) may be a metallic layer or an ink layer formed from a method such as vapor deposition or sputtering optionally followed by a patterning process. The ink pattern may be formed by a printing process such as gravure, flexo, screen, sublimation heat transfer or the like, on a substrate layer.

The substrate layer may be a plastic layer or an insulator-coated metal or metal oxide foil formed from carbon steel, stainless steel, Al, Sn, Ni, Cu, Zn, Mg or an alloy or oxide thereof.

The decorative designs may also be pre-shaped by thermoforming. In this case, the carrier layer (15) becomes part of the molded article. The decorative layer having raised or recessed patterns is typically in the range of about 0.2 to about 1 mm, preferably in the range of about 0.3 to about 0.7 mm, in thickness. It is usually thermoformed from an ABS (acrylonitril-butadiene-styrene), polycarbonate, acrylics, polystyrene or PVC sheet in a mold.

Alternatively, the decorative layer may be also pre-shaped by high pressure forming involving the use of high-pressure air to create decorative designs on a film. The decorative layer may also be formed by hydroforming in which a hydrostatic bladder, rather than air, serves as the forming mechanism.

The durable layer (12) disclosed herein constitutes the present invention. The durable layer is formed from a composition comprising (i) an amino crosslinker, (ii) a UV curable monomer or oligomer having at least one functional group reactive with the amino crosslinker, (iii) an acid catalyst, and (iv) a photoinitiator.

The amino crosslinkers suitable for the present invention may include, but are not limited to, amine-aldehyde condensates, carboxyl modified amino resins and other amino compounds. Examples of amine-aldehyde condensates include formaldehyde condensates of a multifunctional amine (i.e., melamine or urea), such as melamine-formaldehyde, benzoguanamine-aldehyde, glycoluril-formaldehyde or the like.

The concentration of the amino crosslinker in the dried durable layer ranges from about 10% to about 80%, preferably from about 20% to about 60% and more preferably about 40% to about 50%, by weight.

Examples of commercially available amine-aldehyde condensates may include products by Cytec, such as Cymel® (melamine formaldyhyde), Melurac® (melamine urea formaldehyde) or Urac® (urea formaldehyde) and products from Surface Specialty UCB, such as Resimene® (melamine-formaldehyde, HM or BM series or urea-formaldehyde, U series), Maprenal® (melamine-formaldehyde or benzoguanamine-formaldehyde), Viamin® (highly reactive urea-formaldehyde with alkyl or nitrocellulose resin) or Modacure® (highly reactive methylated melamine-formaldehyde modified styrene allyl alcohol resin).

The UV curable monomers or oligomers suitable for the present invention must have at least one functional group reactive with the amino crosslinker and also at least one UV crosslinkable functionality. The functional group reactive with the amino crosslinker may be hydroxyl, carboxyl, thiol, amine, amide, urethane or the like, with hydroxyl and carboxyl as the more preferred.

The UV crosslinkable functionality may be an acrylate, methacrylate, allyl, vinyl ether, epoxide or a combination thereof, with acrylate, methacrylate or vinyl ether as the more preferred.

The equivalent weight of the functional group reactive with the amino crosslinker is preferably less than about 300 g/eq., more preferably less than about 200 g/eq. The equivalent weight of the UV crosslinkable functionality is preferably less than about 500 g/eg, more preferably less than about 200 g/eq. The term “equivalent weight” is defined as the molecular weight of the monomer or oligomer divided by the number of the functionality.

The concentration of the UV curable monomer or oligomer in the dried durable layer may range from about 10% to about 60%, preferably from about 20% to about 55% and more preferably about 20% to about 40%, by weight.

Specific UV curable monomers or oligomers suitable for the present invention may include hydroxyalkyl acrylate, hydroxyalkyl methacrylate, hydroxyl epoxide, carboxyl acrylate and carboxylmethacrylate, with 4-hydroxybutyl acrylate, hydroxyethylacrylate and hydroxypropyl acrylate as the more preferred.

The amino crosslinker and the UV curable monomer or oligomer used in the durable layer composition may be bonded together to form a prepolymer. For example, the amino crosslinker may first pre-react with the UV curable monomer or oligomer in a reaction vessel at a high temperature to form the prepolymer. The reaction can be stopped before the gellation starts. The pre-polymer is then used in the durable layer composition to speed up the thermal curing process. It is understood that the scope of the present invention encompasses both the durable layer composition comprising the amino crosslinker and the UV curable monomer or oligomer as individual components and also the durable layer composition comprising the amino crosslinker and the UV curable monomer or oligomer bonded together in the form of a prepolymer.

To facilitate the thermal cure reaction, an acid catalyst is required. p-Toluenesulfonic acid is usually recommended for this purpose. The catalyst may be added in with the other components and it is present in the amount of about 0.5% to about 8% by weight, preferably about 1% to about 3% by weight, of the total composition.

Other acid catalysts suitable for facilitating the thermal cure may include inorganic acids such as hydrochloric acid or sulfuric acid and organic acids such as phosphoric acid derivatives or many of the proprietary sulfuric acid derivatives such as DDBSA (dodecylbenzene sulfonic acid) and DNNDSA (dinonyl naphthalene disulfonic acid).

To facilitate the UV curing, the durable layer composition of the present invention also comprises a photoinitiator (e.g., Norrish Type 1, Type 2 and Type 3 photoinitiators, such as ITX [isopropyl thioxanthone], Irgacure 651, 907, 369 or 184 from Ciba Specialty Chemicals).

The photoinitiator may be present in the composition in the amount of about 1% to about 5% by weight, preferably about 2% to about 3% by weight, of the total composition.

In addition to the amino crosslinker, the UV curable monomer or oligomer, the acid catalyst and the photoinitiator, the durable layer composition of the present invention may further comprise one or more of the following components: a binder, a multifunctional polymer or oligomer that is reactive with the amino crosslinker, a filler, an adhesion promoter, or an antioxidant.

In one embodiment, a binder is added to the composition for widening the coating process window of the durable layer. Suitable binders may include, but are not limited to, cellulose derivatives such as CAB (cellulose acetate butyrate), CAP (cellulose acetate propionate), hydroxypropyl cellulose (HPC), hydroxybutyl cellulose (HBC), hydroxyethyl cellulose (HEC), methyl cellulose (MC), carboxymethyl cellulose (CMC), carboxymethylcellulose acetate butyrate (CMCAB) or a copolymer thereof, styrene-acrylic acid copolymer (Joncryl polymer), polyvinyl alcohol derivatives such as polyvinyl acetal, polyvinyl butyral or copolymers thereof or polymethylmethacrylate (PMMA). Particularly preferred polymers include cellulose acetate, cellulose acetate butyrate, cellulose acetate propionate, polyvinyl acetal, PMMA and copolymers thereof.

The binder may be present in the composition in the amount of about 5% to about 20% by weight, preferably about 5% to about 10% by weight, of the total composition.

In another embodiment, the composition may further comprise a multifunctional polymer or oligomer in order to increase flexibility of the durable layer. For this purpose, the multifunctional polymer or oligomer must have functional groups (such as hydroxyl, carboxyl, thiol, amine, amide or urethane) which may participate in the formation of the network through crosslinking. In some cases, the amino crosslinker may be modified to include such a multifunctional polymer or oligomer. For example, Resimene 797 is a modified melamine-formaldehyde containing about 20% of styrene allyl alcohol and Resimene 2040 is a modified melamine-formaldehyde containing about 40% of styrene allyl alcohol. Alternatively, a multifunctional polymer or oligomer may be separately added. Examples of suitable multifunctional polymers may include, but are not limited to, hydroxyl-polyester resins, styrene-allyl alcohol copolymer polyols, acrylic polyols and polyacids, with polyol resins, styrene-allyl alcohol copolymer polyols and acrylic polyols as the more preferred.

Commercially available multifunctional polymers or oligomers may include SAA® (styrene-allyl alcohol copolymer polyols), Acryflow® (acrylic polyols) and Joncryl® (styrene-acrylic copolymer polyols).

The multifunctional polymer or oligomer may be present in the composition in the amount of about 1% to about 50% by weight, preferably about 5% to about 20% by weight, of the total composition.

In a further embodiment, the composition may further comprise a filler to increase the hardness and abrasion resistance of the coating. Suitable fillers may include silica, CaCO₃, microgel particles or mica, especially silica.

The filler may be present in the composition in the amount of about 3% to about 20% by weight, preferably about 5% to 10% by weight, of the total composition.

In a further embodiment, the composition may further comprise an adhesion promoter. Suitable adhesion promoters may include, but are not limited to, acrylic acid esters, metallic acrylates, organic chelates, organic titanates or zirconates, titanium phosphate complexes and silane coupling agents, with acrylic acid esters as the more preferred. Examples of commercially available adhesion promoters include CD90050, CD9051 and CD9052 (acrylic acid esters, supplied by Sartomer).

The adhesion promoter may be present in the composition in the amount of about 3% to about 12% by weight, preferably about 3% to about 5% by weight, of the total composition.

In yet a further embodiment, an antioxidant (e.g., BHT [butylated hydroxytoluene], MEHQ [hydroquinone monomethylether] or tetrakis[methylene-3(3′,5′-di-tert-butyl-4-hydroxyphenyl)propionate]methane) may be added.

The antioxidant may be present in the composition in the amount of about 0.1% to about 2% by weight, preferably about 0.2% to about 0.4% by weight, of the total composition.

In a preferred embodiment, the durable layer of the present invention may comprise an amino crosslinker, a UV curable monomer or oligomer having at least one functional group reactive with the amino crosslinker, an acid catalyst, a photoinitiator and optionally an antioxidant.

In addition to the components mentioned above, the composition may further comprise additives such as photosensitizers (e.g., ITX), oxygen scavengers (e.g., triethylamine, triethanolamine, N-methyl diethanolamine, alkyl N,N-dimethylaminobenzoate or 2,6-diisopropyl-N,N-dimethylaniline), UV absorbers (e.g., triazine or benzotriazole derivatives) or light stabilizers (e.g., hindered amine light stabilizers), lubricants (e.g., silicon acrylates, zinc stearate or microcrystalline wax) or colorants.

The typical concentration range of the photosensitizer, if present, may be about 1% to about 5% by weight of the total composition. The typical concentration range of the oxygen scavenger, if present, may be about 1% to about 5% by weight of the total composition. The typical concentration range of the UV absorber, if present, may be about 0.5% to about 4% by weight of the total composition. The typical concentration range of the light stabilizer, if present, may be about 0.1% to about 3% by weight of the total composition. The typical concentration range of the lubricant, if present, may be about 0.5% to about 5% by weight of the total composition.

For the formation of the durable layer, the four main components, (i) the amino crosslinker, (ii) the UV curable monomer or oligomer, (iii) the acid catalyst, and (iv) the photoinitiator, along with the optional component(s) and additive(s) are dispersed or dissolved in a suitable solvent, such as ketones, esters, ethers, glycol ethers, glycolether esters, pyrrolidones, with ketones and esters such as methyl ethyl ketone, (MEK), methyl propyl ketone (MPK), cyclohexanone, ethyl acetate, propyl acetate and butyl acetate as the more preferred.

In the formation of the in-mold decorative tape or strip (10), the release layer (11), the durable layer (12), the decorative design layer (13) and the adhesive layer (14) are sequentially coated onto the carrier layer (15). The coating may be accomplished by coating methods such as slot coating, doctor blade coating, gravure coating, roll coating, comma coating, lip coating and the like or printing methods such as gravure printing, screen printing and the like.

After the decorative tape or strip is formed, the thermal cure is performed during the drying of the durable layer coating step, optionally with a post cure step after the coating. The thermal cure can be carried out at about 80° C. to about 150° C. for various lengths of time, for example, several seconds to hours, depending on the curing conditions and the composition. The UV cure is performed after the injection molding process when the protective layer has been transferred to the surface of the molded article. The molded articles are placed on a UV conveyor that is running at, for example, 0.6 ft/min to 10 ft/min. The UV curing energy needed is usually in the range of from about 0.1 to about 5 J/cm², preferably about 0.3 to about 1.2 J/cm².

The durable layer of the present invention is suitable for all in-mold decoration processes for the manufacture of a plastic article. Examples of the material suitable for the article may include, but are not limited to, thermoplastic materials such as polystyrene, polyvinyl chloride, acrylics, polysulfone, polyarylester, polypropylene oxide, polyolefins, acrylonitrile-butadiene-styrene copolymers (ABS), methacrylate-acrylonitrile-butadiene-styrene copolymers (MABS), polycarbonate, polybutylene terephthalate (PBT), polyethylene terephthalate (PET), polyurethanes and other thermoplastic elastomers or blends thereof, and thermoset materials such as reaction injection molding grade polyurethanes, epoxy resin, unsaturated polyesters, vinylesters or composites, prepregs and blends thereof.

The article may be a plastic cover of a cell phone or pager. In fact, the durable layer is useful for any plastic articles manufactured from an in-mold decoration process, such as personal accessories, toys or educational devices, plastic cover of a personal digital assistant or e-book, credit or smart cards, identification or business cards, face of an album, watch, clock, radio or camera, dashboard in an automobile, household items, laptop computer housings and carrying cases or front control panels of any consumer electronic equipments. This is clearly not exhaustive. Other suitable plastic articles would be clear to a person skilled in the art and therefore they are all encompassed within the scope of the present invention. The durable layer of the present invention is also useful in applications such as the thermal transfer protective coating for thermal printing, inkjet printing and passport and other identification applications.

The present invention has achieved the purpose of providing a durable layer or protective coating for in-mold decoration which has excellent surface quality with a wider geometric tolerance, at low cost.

### EXAMPLES

The following examples are given to enable those skilled in the art to more clearly understand, and to practice, the present invention. They should not be considered as limiting the scope of the invention, but merely as being illustrative and representative thereof.

### Example 1

### Preparation of IMD Tape having a Durable Layer between Release and Adhesive Layers

102.8 Grams of a solution of 51.4 gm of Cymel M/F 303 (melamine formaldehyde resin, from Cytec Industries Inc.) in 51.4 gm of MEK, 33.5 gm of 4-hydroxybutyl acrylate (from TCI), 10 gm of CAB-531-1 (cellulose acetate butyrate, from Eastman Chemical Co.) in 90 gm of MEK were thoroughly mixed in a round bottomed flask. The solution was heated to 80° C. under stirring and to this mixture 3 gm of p-toluenesulfonic acid (from Aldrich) in 4.5 gm of 2-propyl alcohol was added. The solution was continuously stirred at 80° C. for 20 minutes and then cooled down to room temperature. 1.43 Grams of BMS [4-(4-methylphenylthiophenyl)-phenylmethanone from Biddle Sawyer, Inc.], 0.76 gm of Irgacure 651 (2,2-dimethoxy-2-phenyl acetophenone from Ciba Specialty Chemicals), 0.14 gm of ITX (isopropyl thioxanthone from Biddle Sawyer, Inc.), 0.095 gm of Irganox 1035 (thiodiethylene bis[3-(3,5-di-tert-butyl-4-hydroxyphenyl)propionate] from Ciba Specialty Chemicals) and 0.19 gm of Tinuvin 123 (decanedioic acid, bis(2,2,6,6-tetramethyl-1-(octyloxy)-4-piperidinyl)ester, reaction products with 1,1-dimethylethylhydroperoxide and octane from Ciba Specialty Chemicals) with 9 gm of MEK were added into the resulting solution. The durable layer composition was then coated on a commercial release layer, BOPP (biaxially oriented polypropylene, from UCB Surface Specialties) with a #2 doctor blade. The coated composite film was air dried and cured at 120° C. for 5 minutes.

An adhesive consisting of 1 part of Sancure 2710 (aliphatic polyurethane from Noveon Inc., Cleveland, Ohio) and 3 parts of DI water was then overcoated onto the cured durable layer using a #16 Meyer bar with a target thickness about 3 um. The resultant film was inserted into an injection mold. A mixture of PMMA (polymethylmethacrylate) and polycarbonate was injected into a mold cavity at 490° F. and 550° F., respectively, with the adhesive layer facing the plastic mixture. The durable layer and the adhesive layer were completely transferred to the molded plastic article after the release film was peeled off. The molded article was then post cured by UV exposure (1 J/cm²) using a Fusion conveyor curing system. The solvent resistance and abrasion resistance of the durable layer were evaluated and the results are summarized in Table 1.

Samples were tested for solvent resistance by the MEK drop test. Abrasion resistance was tested using Norman abrasion tester with a load of 175 gm and 50 cycles. Pencil hardness was tested with a load of 500 gm.

### Example 2

78.0 Grams of a solution of 39.0 gm of Resimene 745 (melamine formaldehyde resin, from UCB Surface Specialties, Inc.) in 39.0 gm of MEK, 20.0 gm of a solution of 10.0 gm Acryflow A140 (acrylic polyol, from Lyondell) in 10.0 gm of MEK, 26 gm of 4-hydroxybutyl acrylate (from TCI), 10.0 gm of CAB-531-1 (cellulose acetate butyrate, from Eastman Chemical Co.) in 90.0 gm of MEK, 10.0 gm of CD9052 (adhesion promoter, from Sartomer) and 5.0 gm of a solution of 2.0 gm of p-toluenesulfonic acid (from Aldrich) in 3.0 gm of 2-propyl alcohol were thoroughly mixed in a three roll mill for about 20 minutes. To this mixture, 1.43 gm of BMS, 0.76 gm of Irgacure 651, 0.14 gm of ITX, 0.1 gm of Irganox 1035 and 0.19 gm of Tinuvin 123, with 9 gm of MEK were added. The rest of the procedure was the same as that of Example 1 and the test results are summarized in Table 1.

### Example 3

20.8 Grams of a solution of 10.4 gm of Cymel M/F 303 in 10.4 gm of MEK, 4.4 gm of 4-hydroxybutyl acrylate, 2.9 gm of MEK-ST, 0.6 gm of CD9051 (trifunctional acid ester adhesion promoter from Sartomer), 0.6 gm of Acryflow A140 in 0.6 gm of MEK, 1.6 gm of CAB-531-1 in 14.4 gm of MEK, and 2 gm of a solution of 0.8 gm of p-toluenesulfonic acid in 1.2 gm of 2-propyl alcohol were mixed thoroughly. To this mixture, 0.29 gm of BMS, 0.15 gm of Irgacure 651, 0.03 gm of ITX, 0.02 gm of Irganox 1035 and 0.038 gm of Tinuvin 123 with 1.8 gm of MEK were added in. The rest of the procedure was the same as that of Example 1 and test results are summarized in Table 1.

### Example 4

20.8 Grams of a solution of 10.4 gm of Cymel 303 in 10.4 gm of MEK, 4.4 gm of 4-hydroxybutyl acrylate, 2.9 gm of MEK-ST, 0.8 gm of Acryflow A140 in 0.8 gm of MEK, 2.0 gm of JPX-197T114-3 (styrene-acrylic acid copolymer from Joncryl polymer) in 8 gm of MEK, and 2 gm of a solution of 0.8 gm of p-toluenesulfonic acid in 1.2 gm of 2-propyl alcohol were mixed thoroughly. To this mixture, 0.29 gm of BMS, 0.15 gm of Irgacure 651, 0.03 gm of ITX, 0.02 gm of Irganox 1035 and 0.038 gm of Tinuvin 123 with 1.8 gm of MEK were added in. The rest of the procedure was the same as that of Example 1 and test results are summarized in Table 1.

### Example 5

15.6 Grams of a solution of 7.8 gm of Resimene 745 in 7.8 grams of MEK, 10.2 gm of CD570 (ethoxylated hydroxyethyl methacrylate from Sartomer), 2 gm of CAB-531-1 in 18 gm of MEK, 1.5 gm of a solution of 0.6 gm of p-toluenesulfonic acid in 0.9 gm of 2-propyl alcohol were mixed thoroughly. To this mixture, 0.29 gm of BMS, 0.15 gm of Irgacure 651, 0.03 gm of ITX, 0.02 gm of Irganox 1035 and 0.038 gm of Tinuvin 123 with 1.8 gm of MEK were added in. The rest of the procedure was the same as that of Example 1. The test results are summarized in Table 1.

### Example 6

### Comparative Example

76 Grams of a solution of 38 gm of Resimene 745 in 38 gm of MEK, 10 gm of CAB-531-1 in 90 gm of MEK and 5 gm of a solution of 2 gm of p-toluenesulfonic acid in 3 gm of 2-propyl alcohol were mixed thoroughly. To this mixture, 1.43 gm of BMS, 0.76 gm of Irgacure 651, 0.14 gm of ITX, 0.095 gm of Irganox 1035 and 0.19 gm of Tinuvin 123 with 9 gm of MEK were added. The rest of the procedure was the same as that of Example 1 and the test results are summarized in Table 1.

TABLE 1

| | Pencil Hardness | Abrasion | MEK |
|---|---|---|---|
| Example | (500 gm) | Resistance | Resistance |
| 1 | >3H | Excellent | Pass |
| 2 | >3H | Excellent | Pass |
| 3 | >3H | Excellent | Pass |
| 4 | >3H | Excellent | Pass |
| 5 | >3H | Excellent | Pass |
| 6 | <2H | Good | Pass |
| (comparative) | | | |

The invention, and the manner and process of making and using it, are now described in such full, clear, concise and exact terms as to enable any person skilled in the art to which it pertains, to make and use the same. It is to be understood that the foregoing describes preferred embodiments of the present invention and that modifications may be made therein without departing from the scope of the present invention as set forth in the claims. To particularly point out and distinctly claim the subject matter regarded as invention, the following claims conclude this specification.

What is claimed is:

1. A durable layer composition for in-mold decoration which comprises:
(i) an amino crosslinker;
(ii) a UV curable monomer or oligomer having at least one functional group reactive with the amino crosslinker;
(iii) an acid catalyst; and
(iv) a photoinitiator.

2. The durable layer composition of claim 1 further comprising one or more of the following:
(v) a binder;
(vi) a multifunctional polymer or oligomer that is reactive with the amino crosslinker;
(vii) a filler;
(viii) an adhesion promoter; or
(ix) an antioxidant.

3. The durable layer composition of claim 1 wherein said amino crosslinker is an amine-aldehyde condensate or a carboxyl modified amino resin.

4. The durable layer composition of claim 1 wherein said amine-aldehyde condensate is a formaldehyde condensate of a multifunctional amine.

5. The durable layer composition of claim 4 wherein said multifunctional amine is melamine or urea.

6. The durable layer composition of claim 1 wherein said amino crosslinker is melamine-formaldehyde, benzoguanamine-aldehyde, or glycoluril-formaldehyde.

7. The durable layer composition of claim 1 wherein said functional group in said UV curable monomer or oligomer is hydroxyl, carboxyl, thiol, amine, amide or urethane.

8. The durable layer composition of claim 1 wherein said UV curable monomer or oligomer comprises an UV crosslinkable functionality selected from the group consisting of acrylate, methacrylate, allyl, vinyl ether, epoxide, and a combination thereof.

9. The durable layer composition of claim 1 wherein said UV curable monomer or oligomer is hydroxyalkyl acrylate, hydroxyalkyl methacrylate, hydroxyl epoxide, carboxyl acrylate, or carboxylmethacrylate.

10. The durable layer composition of claim 1 wherein said UV curable monomer or oligomer is 4-hydroxybutyl acrylate, hydroxyethylacrylate, or hydroxypropyl acrylate.

11. The durable layer composition of claim 1 wherein said acid catalyst is an inorganic or organic acid catalyst.

12. The durable layer composition of claim 11 wherein said inorganic acid catalyst is hydrochloric acid or sulfuric acid.

13. The durable layer composition of claim 11 wherein said organic acid catalyst is p-toluenesulfonic acid, a phosphoric acid derivative, dodecylbenzene sulfonic acid, or dinonyl naphthalene disulfonic acid.

14. The durable layer composition of claim 1 wherein said photoinitiator is Norrish Type 1, Type 2 or Type 3 photoinitiator.

15. The durable layer composition of claim 2 wherein said binder is a cellulose derivative or a copolymer thereof, a polyvinyl alcohol derivative or a copolymer thereof, or polymethylmethacrylate.

16. The durable layer composition of claim 2 wherein said binder is cellulose acetate, cellulose acetate butyrate, cellulose acetate propionate, polyvinyl acetal, or polymethylmethacrylate.

17. The durable layer composition of claim 2 wherein said multifunctional polymer or oligomer comprises a functional group selected from the group consisting of hydroxyl, carboxyl, thiol, amine, amide, and urethane.

18. The durable layer composition of claim 2 wherein said amino crosslinker is modified to contain a multifunctional polymer or oligomer.

19. The durable layer composition of claim 2 wherein said multifunctional polymer or oligomer is a hydroxyl-polyester resin, styrene-allyl alcohol copolymer polyol, acrylic polyol, or polyacid.

20. The durable layer composition of claim 2 wherein said multifunctional polymer or oligomer is a polyol resin, styrene-allyl alcohol copolymer polyol, or acrylic polyol.

21. The durable layer composition of claim 2 wherein said adhesion promoter is an acrylic acid ester, metallic acrylate, organic chelate, organic titanate or zirconate, titanium phosphate complex, or silane coupling agent.

22. The durable layer composition of claim 2 wherein said adhesion promoter is an acrylic acid ester.

23. The durable layer composition of claim 2 wherein said filler is a silica, CaCO₃, microgel particles, or mica.

24. The durable layer composition of claim 2 wherein said antioxidant is butylated hydroxytoluene, hydroquinone monomethylether, or tetrakis[methylene-3(3′,5′-di-tert-butyl-4-hydroxyphenyl)propionate]methane).

25. The durable layer composition of claim 2 which comprises an amino crosslinker, a UV curable monomer or oligomer having at least one functional group reactive with the amino crosslinker, an acid catalyst, a photoinitiator, and an antioxidant.

26. The durable layer composition of claim 25 further comprising a multifunctional polymer or oligomer reactive with said amino crosslinker.

27. The durable layer composition of claim 25 further comprising a binder.

28. The durable layer composition of claim 25 further comprising an adhesion promoter.

29. A durable layer for in-mold decoration which is formed from a composition comprising
(i) an amino crosslinker;
(ii) a UV curable monomer or oligomer having a functional group reactive with said aminocrosslinker;
(iii) an acid catalyst;
(iv) a photoinitiator, and
optionally one or more of the following: a binder, a multifunctional polymer or oligomer that is reactive with the amino crosslinker, a filler, an adhesion promoter, or an antioxidant.

30. A plastic article having a durable layer formed from a composition comprising
(i) an amino crosslinker;
(ii) a UV curable monomer or oligmer having a functional group reactive with said amino crosslinker;
(iii) an acid catalyst;
(iv) a photoinitiator, and
optionally one or more of the following: a binder, a multifunctional polymer or oligomer that is reactive with the amino crosslinker, a filler, an adhesion promoter, or an antioxidant.

31. The article of claim 30 which is a plastic cover of a cell phone or pager, a personal accessory, toy or educational device, plastic cover of a personal digital assistant or e-book, credit or smart card, identification or business card, face of an album, watch, clock, radio or camera, dashboard in an automobile, household item, a laptop computer housing and carrying case or front control panel of a consumer electronic equipment, a thermal transfer protective coating of identification, passport, or inkjet printed or thermal printed image.

32. A decorative tape or strip for in-mold decoration, which tape or strip comprises
a) a carrier layer;
b) a release layer;
c) a durable layer formed from a composition comprising
(i) an amino crosslinker;
(ii) a UV curable monomer or oligomer having a functional group reactive with said amino crosslinker;
(iii) an acid catalyst;
(iv) a photoinitiator; and optionally
one or more of the following: a binder, a multifunctional polymer or oligomer that is reactive with the amino crosslinker, a filler, an adhesion promoter or an antioxidant;
d) a decorative layer; and
e) an adhesive layer.

33. The decorative tape or strip of claim 32 wherein said decorative layer is a metallic layer or an ink layer.
